(19) United States
(12) Patent Application Publication
(10) Pub. No.: US 2026/0083067 A1
(43) Pub. Date: Mar. 26, 2026

(54) Collapsible Plant Pot Device

(71) Applicant: Kimberlee Jones, Kewanee, IL (US)

(72) Inventor: Kimberlee Jones, Kewanee, IL (US)

(21) Appl. No.: 18/958,566

(22) Filed: Nov. 25, 2024

Related U.S. Application Data
(60) Provisional application No. 63/698,075, filed on Sep. 24, 2024.

(51) Int. Cl. A01G 9/02

(52) U.S. Cl. CPC A01G 9/026

(57) ABSTRACT

A collapsible plant pot device is disclosed, which is a series of collapsible pots that are ideal for growing plants in small areas, such as apartments, balconies, or small rooms. The collapsible plant pot device comprises a collapsible body component that can be extended or retracted, as needed for storage or based on the size of the plant to be potted. The body component comprises a plurality of aeration holes and a recessed ring on the top and slits on the bottom of each pot for stacking on top of each other, where they interlock securely. Typically, the body component is manufactured of silicone, plastic, or recycled, biodegradable materials. The collapsible plant pot device is available in a variety of colors and won't fade due to age.

### CROSS-REFERENCE TO RELATED APPLICATION

The present application claims priority to, and the benefit of, U.S. Provisional Application No. 63/698,075, which was filed on Sep. 24, 2024, and is incorporated herein by reference in its entirety.

### FIELD OF THE INVENTION

The present invention relates generally to the field of collapsible plant pot devices. More specifically, the present invention relates to a collapsible silicone pot for storing and growing potted plants. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in collapsible plant pot devices. Generally, people may enjoy growing plants and decorating apartments, homes, offices, and other indoor areas with potted plants. However, plant enthusiasts are often confronted with several obstacles, including limited space, constant replanting for plants that grow quickly, and various health issues for the plants. Further, standard pots are not collapsible and take up significant space, making it difficult to use other decorations or store the pots when they are not in use. Storing rigid pots without proper stacking and organization can lead to clutter and accidental damage like cracking and chipping.

Plant pots are commonplace in any household that features flowers or plants. Pots allow the user to contain the components of the plant, especially the soil, to allow the plant to thrive while keeping the area around the plant clean. However, when not in use the pots must be stacked and stored away. Users with little space may not have the room to store multiple pots, causing some users to stop growing plants and flowers.

Accordingly, there is a demand for an improved collapsible plant pot device that allows users to easily stack and store multiple pots without worry of breakage or needing additional room More particularly, there is a demand for a collapsible plant pot device that can be used for small or large plants, as the pots can be extended or collapsed, as needed.

Therefore, there exists a long-felt need in the art for a collapsible plant pot device that provides users with a collapsible silicone pot for storing and growing potted plants. There is also a long-felt need in the art for a collapsible plant pot device that features one or more interlocking sections that enable the pots to be collapsed for easy, convenient, and clutter-free storage. Further, there is a long-felt need in the art for a collapsible plant pot device that offers an aesthetically pleasing design available in several colors that can suit various user preferences and indoor and outdoor environments. Moreover, there is a long-felt need in the art for a device that includes aeration holes in the pot that promote proper airflow to the roots to prevent root rot and to encourage healthy plant growth. Further, there is a long-felt need in the art for a collapsible plant pot device that utilizes eco-friendly materials that facilitate constant reuse of the plants for long periods of time. Finally, there is a long-felt need in the art for a collapsible plant pot device that includes a slit at the bottom of each pot for interlocking the pots when stacked.

The subject matter disclosed and claimed herein, in one embodiment thereof, comprises a collapsible plant pot device. The device is a series of collapsible pots that are ideal for growing plants in small areas, such as apartments, balconies, or small rooms. The collapsible plant pot device comprises a collapsible body component that can be extended or retracted, as needed for storage or based on the size of the plant to be potted. The body component comprises a plurality of aeration holes and a recessed ring on the top and slits on the bottom of each pot for stacking on top of each other, where they interlock securely. Typically, the body component is manufactured of silicone, plastic, or recycled, biodegradable materials. The collapsible plant pot device is available in a variety of colors and won't fade due to age.

In this manner, the collapsible plant pot device appeals to a wide range of users, including urban gardeners with limited space, busy individuals who appreciate convenience, and eco-conscious consumers looking for sustainable gardening solutions. Further, hobbyists, plant enthusiasts, and even professionals in landscaping or interior design can benefit from the practicality and style of these collapsible pots.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a collapsible plant pot device. The collapsible plant pot device comprises a collapsible body component that can be extended or retracted, as needed for storage or based on the size of the plant to be potted. The body component comprises a plurality of aeration holes, a recessed ring on the top, and slits on the bottom of each pot device for stacking on top of each other.

In one embodiment, the collapsible plant pot device is a collapsible planting pot that allows a user to easily access and/or remove the contents inside the planting pot, as well as to store multiple pots easily in a stacked position. Further, the collapsible plant pot device appeals to a wide range of users, including urban gardeners with limited space, busy individuals who appreciate convenience, and eco-conscious consumers looking for sustainable gardening solutions. Further, hobbyists, plant enthusiasts, and even professionals in landscaping or interior design can benefit from the practicality and style of these collapsible planting pot devices.

In one embodiment, the collapsible plant pot device allows a user to easily collapse or retract the device, as needed. Due to the collapsible nature of the device, the collapsible plant pot device can be used for large or small plants. For example, a user can extend the device to its full height for large plants or flowers or retract it completely or partially for small plants or flowers. Depending on the size of the plant or flower to be potted, the user can extend or retract the device as little or as lot, as needed. Further, the collapsible plant pot device allows the user to expand or retract the device, as needed. Thus, a user can store multiple devices in a collapsed position which makes it ideal for growing plants in smaller spaces, such as apartments, porches, balconies, or small rooms, etc., or any other suitable small space.

In one embodiment, the collapsible plant pot device comprises a body component. The body component is a pot-shaped structure used to contain soil and plant or flower substances. The body component may be available in multiple sizes, allowing users to pot varying sizes of plants and/or flowers. The body component comprises a rim, a base or bottom, and a series of annular pleats that form the sidewall of the body component. The rim is the protective edge of the body component. The base or bottom is the structural foundation of the body component. The series of annular pleats is a set of foldable sections of the body component, which enables the collapsibility of the present invention. The rim and the base are rigid and act to maintain the device in position, when in an extended configuration, whereas the series of annular pleats are flexible and collapse and extend, as needed.

In one embodiment, the series of annular pleats comprise a beginning pleat, at least one intermediate pleat, and an ending pleat. The beginning pleat is the smallest, lowest pleat of the body component when in an upright position. Each of the intermediate pleats proceed the beginning pleat and is gradually larger than a preceding pleat along the body component when in an upright position. The ending pleat is the largest and highest pleat of the body component when in an upright position. Each of the series of annular pleats comprises a first edge and a second edge. The second edge is larger than the first edge for each of the series of annular pleats. The first edge of the beginning pleat is perimetrically and foldably connected around the base in order to allow the beginning pleat to be collapsed towards the base. The first edge of an arbitrary intermediate pleat is foldably connected along the second edge of a preceding annular pleat from the series of annular pleats. The arbitrary intermediate pleat is any of the intermediate pleats. The second edge of the arbitrary intermediate pleat is foldably connected along the first edge of a subsequent annular pleat from the series of annular pleats. The second edge of the ending pleat is perimetrically and foldably connected around the rim. In further detail, the first edge of each intermediate pleat is connected to the second edge of a lower pleat along the body component in an upright position. This arrangement starts from the beginning pleat towards the ending pleat along the body component in an upright position. Moreover, the beginning pleat is the initial preceding annular pleat and the ending pleat is the final subsequent annular pleat.

In one embodiment, the body component may be arranged into an operative configuration. The operative configuration is where the body component is fully extended in an upright position in order to hold soil and a plant or flower substance. In the operative configuration, the rim and the base are positioned offset from each other. Moreover, the series of annular pleats are positioned in between the rim and the base. This arrangement properly positions the parts of the body component in order for the body component to hold soil and a plant or flower substance. A user may arrange the body component into the operative configuration by holding down the base and extending the body component by pulling the rim away from the base. Furthermore, the body component tapers from the rim to the base in order for the body component in the operative configuration to portray the conventional pot shape.

In one embodiment, the body component may be arranged into a collapsed configuration. The collapsed configuration allows a user to access and/or remove the contents placed inside the body component and store the device in a stacked orientation. In the collapsed configuration, the base is encircled by the beginning pleat. Moreover, the preceding annular pleat is encircled by an arbitrary intermediate pleat. The arbitrary intermediate pleat is encircled by the subsequent annular pleat. Furthermore, the ending pleat is encircled by the rim. This arrangement properly positions the parts of the body component in order for a user to remove the contents and store the device in a stacked orientation. A user may arrange the body component into the collapsed configuration by pushing the rim down towards the base. Furthermore, the preceding annular pleat and the arbitrary intermediate pleat are oriented at a first acute angle with each other. The arbitrary intermediate pleat and the subsequent annular pleat are oriented at a second acute angle with each other. This arrangement allows each of the series of annular pleats to fold into each other in order for the body component to be arranged into the collapsed configuration. The first acute angle and the second acute angle are a pair of alternate interior angles. The first acute angle and the second acute angle are formed when each of the series of annular pleats are folded along each other.

In one embodiment, the rim of the body component comprises a recessed ring around its inside perimeter. The recessed ring allows multiple collapsible plant pot devices to be stacked on one another. The ring can be any suitable width, as long as the ring is positioned around the entire inside perimeter and is sized to accept a base of another body component from another collapsible plant pot device stacked on top. The recessed ring allows the other base to be positioned within it, allowing users to stack multiple devices on top of each other with ease.

In one embodiment, the base of the body component comprises at least one pair of slits positioned on opposing sides of the base. The slits are rectangular openings in the edges of the base. The slits have a width that allows the edges of the rim of another device to be positioned within the slits. The slits allow multiple devices to be stacked one atop another and interlocked. This allows for easy storage and prevents the stacks of devices from falling over. The slits interlock with the rim and securely hold the devices in a stacked arrangement for storage. Specifically, when the devices are fully collapsed and nestled together, the slits will interlock with the rigid rim edges, allowing users to stack multiple devices on top of each other. To use a device, a user simply takes one of the collapsed devices from the stack and expands it by pulling the device open and then placing it in a desired position for planting a plant within.

In one embodiment, the base of the body component comprises a plurality of aeration holes. The aeration holes are through holes within the base to allow water from the soil, not absorbed by the plant, to flow through. The plurality of aeration holes traverses through the base and are distributed across the base. The plurality of aeration holes keeps the soil within the base component healthy, allowing water and air to pass through, as needed.

In one embodiment, the body component can be positioned on a reservoir tray. The reservoir tray functions as a reservoir and is used to collect water until the water is absorbed by the plant and/or flower inside the body component. Typically, the reservoir tray is not secured to the base but allows the body component to merely rest on the reservoir tray. Thus, the reservoir tray can be easily removed, when not needed.

In one embodiment, the collapsible plant pot device is available in a variety of colors and designs, depending on the needs and/or wants of a user. Typically, the device is manufactured with a silicone material, which prevents fading of the colors due to age. Further, the silicone material creates a smooth surface for the device, allowing it to be easy to clean, and requiring no special maintenance, making the collapsible plant pot devices low maintenance and convenient.

In one embodiment, the collapsible plant pot device is manufactured from silicone, plastic, or recycled, biodegradable materials, or other suitable materials as is known in the art, or a combination of such materials.

In yet another embodiment, the collapsible plant pot device comprises a plurality of indicia.

In yet another embodiment, a method of stacking planting pots with ease is disclosed. The method includes the steps of providing a collapsible plant pot device comprising a body component with collapsible sections. The method also comprises extending the body component to hold a plant. Further, the method comprises collapsing the body component down for storage. The method also comprises stacking one collapsed body component onto another collapsed body component. Finally, the method comprises interlocking the collapsed body components together via the slits on the bottom of each body component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the collapsible plant pot device of the present invention in accordance with the disclosed architecture;

FIG. 2 illustrates a perspective view of one embodiment of the collapsible plant pot device of the present invention showing the device in use in accordance with the disclosed architecture;

FIG. 3 illustrates a perspective view of one embodiment of the collapsible plant pot device of the present invention showing the pots in several different colors in accordance with the disclosed architecture;

FIG. 4 illustrates a perspective view of one embodiment of the collapsible plant pot device of the present invention showing the pot device extended for holding a plant in accordance with the disclosed architecture;

FIG. 5 illustrates a perspective view of one embodiment of the collapsible plant pot device of the present invention showing the interlocking sections of the pot in accordance with the disclosed architecture; and

FIG. 6 illustrates a flowchart showing the method of stacking planting pots with ease in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a collapsible plant pot device that provides users with a collapsible silicone pot for storing and growing potted plants. There is also a long-felt need in the art for a collapsible plant pot device that features one or more interlocking sections that enable the pots to be collapsed for easy, convenient, and clutter-free storage. Further, there is a long-felt need in the art for a collapsible plant pot device that offers an aesthetically pleasing design available in several colors that can suit various user preferences and indoor and outdoor environments. Moreover, there is a long-felt need in the art for a device that includes aeration holes in the pot that promote proper airflow to the roots to prevent root rot and to encourage healthy plant growth. Further, there is a long-felt need in the art for a collapsible plant pot device that utilizes eco-friendly materials that facilitate constant reuse of the plants for long periods of time. Finally, there is a long-felt need in the art for a collapsible plant pot device that includes a slit at a bottom of each pot for interlocking the pots when stacked.

The present invention, in one exemplary embodiment, is a novel collapsible plant pot device. The collapsible plant pot device comprises a collapsible body component that can be extended or retracted, as needed for storage or based on the size of the plant to be potted. The body component comprises a plurality of aeration holes and a recessed ring on the top and slits on the bottom of each pot for stacking on top of each other, where they interlock securely. Typically, the body component is manufactured of silicone, plastic, or recycled, biodegradable materials. The collapsible plant pot device is available in a variety of colors and won't fade due to age. The present invention also includes a novel method of stacking planting pots with ease. The method includes the steps of providing a collapsible plant pot device comprising a body component with collapsible sections. The method also comprises extending the body component to hold a plant. Further, the method comprises collapsing the body component down for storage. The method also comprises stacking one collapsed body component onto another collapsed body component. Finally, the method comprises interlocking the collapsed body components together via the slits on the bottom of each body component.

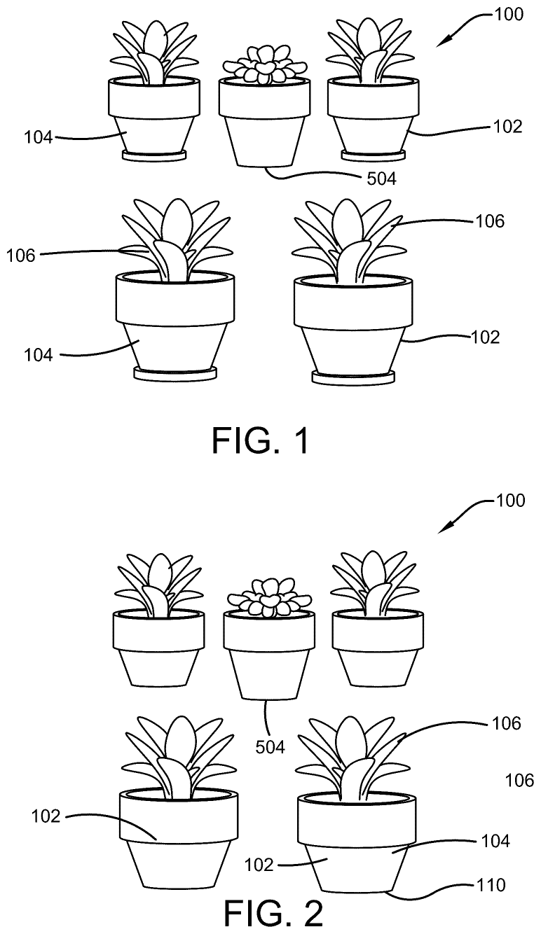

Referring initially to the drawings, FIG. 1 illustrates a perspective view of one embodiment of the collapsible plant pot device 100 of the present invention. In the present embodiment, the collapsible plant pot device 100 is an improved collapsible plant pot device 100 that provides a user with a collapsible pot for a potted plant or flower. Specifically, the collapsible plant pot device 100 comprises a body component 102 with collapsible sections (i.e., annular pleats 104). The collapsible body component 102 can be extended or retracted, as needed for storage or based on the size of the plant or flower to be potted.

Generally, the collapsible plant pot device 100 is a collapsible planting pot that allows a user to easily access and/or remove the contents inside the planting pot, as well as to store multiple pots easily in a stacked position. Further, the collapsible plant pot device 100 appeals to a wide range of users, including urban gardeners with limited space, busy individuals who appreciate convenience, and eco-conscious consumers looking for sustainable gardening solutions. Further, hobbyists, plant enthusiasts, and even professionals in landscaping or interior design can benefit from the practicality and style of these collapsible planting pot devices 100.

Furthermore, the collapsible plant pot device 100 allows a user to easily collapse or retract the device 100, as needed. Due to the collapsible nature of the device 100, the collapsible plant pot device 100 can be used for large or small plants 106. For example, a user can extend the device 100 to its full height for large plants 106 or flowers or retract it completely or partially for small plants 106 or flowers. Depending on the size of the plant 106 or the flower to be potted, the user can extend or retract the device 100 as little or as lot, as needed. Further, the collapsible plant pot device 100 allows the user to expand or retract the device 100, as needed. Thus, a user can store multiple devices 100 in a collapsed position which makes it ideal for growing plants 106 in smaller spaces, such as apartments, porches, balconies, or small rooms, etc., or any other suitable small space.

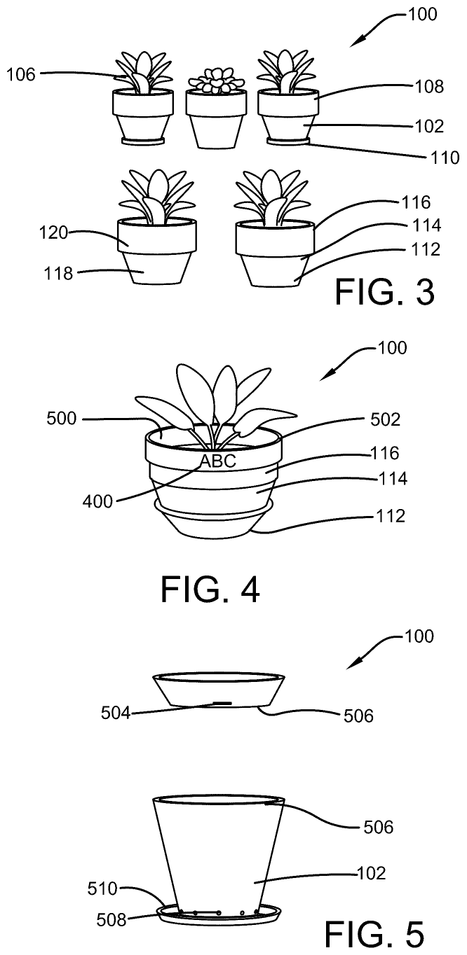

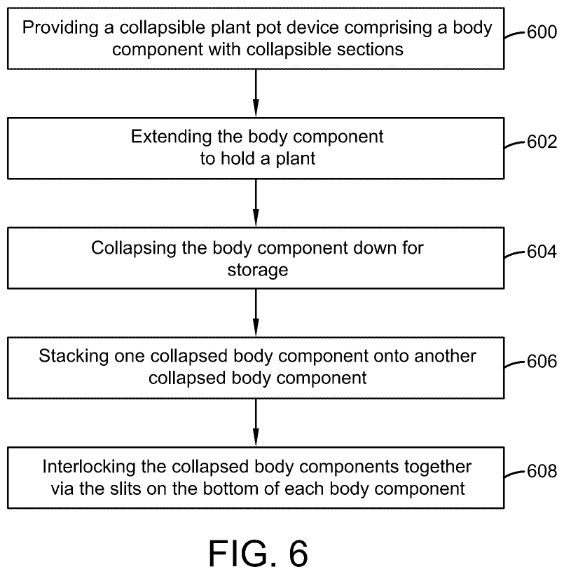

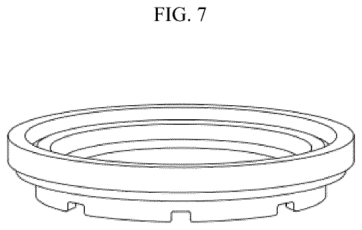

As shown in FIGS. 2-4, the collapsible plant pot device 100 comprises a body component 102. The body component 102 is a pot-shaped structure used to contain soil and plant 106 or flower substances. The body component 102 may be available in multiple sizes, allowing users to pot varying sizes of plants 106 and/or flowers. The body component 102 comprises a rim 108, a base 110 or bottom, and a series of annular pleats 104 that form the sidewall of the body component 102. The rim 108 is the protective edge of the body component 102. The base 110 or bottom is the structural foundation of the body component 102. The series of annular pleats 104 is a set of foldable sections of the body component 102, which enables the collapsibility of the present invention. The rim 108 and the base 110 are rigid and act to maintain the device 100 in position, when in an extended configuration, whereas the series of annular pleats 104 are flexible and collapse and extend, as needed.

Further, the series of annular pleats 104 comprise a beginning pleat 112, at least one intermediate pleat 114, and an ending pleat 116. The beginning pleat 112 is the smallest, lowest pleat of the body component 102 when in an upright position. Each of the intermediate pleats 114 proceed to the beginning pleat 112 and is gradually larger than a preceding pleat along the body component 102 when in an upright position. The ending pleat 116 is the largest and highest pleat of the body component 102 when in an upright position. Each of the series of annular pleats 104 comprises a first edge 118 and a second edge 120. The second edge 120 is larger than the first edge 118 for each of the series of annular pleats 104. The first edge 118 of the beginning pleat 112 is perimetrically and foldably connected around the base 110 in order to allow the beginning pleat 112 to be collapsed towards the base 110. The first edge 118 of an arbitrary intermediate pleat 114 is foldably connected along the second edge 120 of a preceding annular pleat from the series of annular pleats 104. The arbitrary intermediate pleat 114 is any of the intermediate pleats 114. The second edge 120 of the arbitrary intermediate pleat 114 is foldably connected along the first edge 118 of a subsequent annular pleat from the series of annular pleats 104. The second edge 120 of the ending pleat 116 is perimetrically and foldably connected around the rim 108. In further detail, the first edge 118 of each intermediate pleat 114 is connected to the second edge 120 of a lower pleat along the body component 102 in an upright position. This arrangement starts from the beginning pleat 112 towards the ending pleat 116 along the body component 102 in an upright position. Moreover, the beginning pleat 112 is the initial preceding annular pleat and the ending pleat 116 is the final subsequent annular pleat.

Additionally, the body component 102 may be arranged into an operative configuration. The operative configuration is where the body component 102 is fully extended in an upright position in order to hold soil and a plant 106 or flower substance. In the operative configuration, the rim 108 and the base 110 are positioned offset from each other. Moreover, the series of annular pleats 104 are positioned in between the rim 108 and the base 110. This arrangement properly positions the parts of the body component 102 in order for the body component 102 to hold soil and a plant 106 or flower substance. A user may arrange the body component 102 into the operative configuration by holding down the base 110 and extending the body component 102 by pulling the rim 108 away from the base 110. Furthermore, the body component 102 tapers from the rim 108 to the base 110 in order for the body component 102 in the operative configuration to portray the conventional pot shape.

Furthermore, the collapsible plant pot device 100 is available in a variety of colors and designs, depending on the needs and/or wants of a user. Typically, the device 100 is manufactured with a silicone material, which prevents fading of the colors due to age. Further, the silicone material creates a smooth surface for the device 100, allowing it to be easy to clean, and requiring no special maintenance, making the collapsible plant pot devices 100 low maintenance and convenient.

In one embodiment, the collapsible plant pot device 100 is manufactured from silicone, plastic, or recycled, biodegradable materials, or other suitable materials as is known in the art, or a combination of such materials.

In yet another embodiment, the collapsible plant pot device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as, but not limited to, patterns, logos, emblems, images, symbols, designs, letters, words, characters, animals, advertisements, brands, etc., that may or may not be plant, planting pot, or brand related.

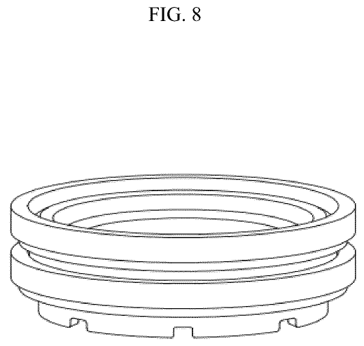

As shown in FIG. 5, the body component 102 may be arranged into a collapsed configuration. The collapsed configuration allows a user to access and/or remove the contents placed inside the body component 102 and store the device 100 in a stacked orientation. In the collapsed configuration, the base 110 is encircled by the beginning pleat 112. Moreover, the preceding annular pleat is encircled by an arbitrary intermediate pleat 114. The arbitrary intermediate pleat 114 is encircled by the subsequent annular pleat. Furthermore, the ending pleat 116 is encircled by the rim 108. This arrangement properly positions the parts of the body component 102 in order for a user to remove the contents and store the device 100 in a stacked orientation. A user may arrange the body component 102 into the collapsed configuration by pushing the rim 108 down towards the base 110. Furthermore, the preceding annular pleat and the arbitrary intermediate pleat 114 are oriented at a first acute angle with each other. The arbitrary intermediate pleat 114 and the subsequent annular pleat are oriented at a second acute angle with each other. This arrangement allows each of the series of annular pleats 104 to fold into each other in order for the body component 102 to be arranged into the collapsed configuration. The first acute angle and the second acute angle are a pair of alternate interior angles. The first acute angle and the second acute angle are formed when each of the series of annular pleats 104 are folded along each other.

In one embodiment, the rim 108 of the body component 102 comprises a recessed ring 500 around its inside perimeter 502. The recessed ring 500 allows multiple collapsible plant pot devices 100 to be stacked on one another. The ring 500 can be any suitable width, as long as the ring 500 is positioned around the entire inside perimeter 502 and is sized to accept a base 110 of another body component 102 from another collapsible plant pot device 100 stacked on top. The recessed ring 500 allows the other base 110 to be positioned within it, allowing users to stack multiple devices 100 on top of each other with ease.

In one embodiment, the base 110 of the body component 102 comprises at least one pair of slits 504 positioned on opposing sides of the base 110. The slits 504 are rectangular openings in the edges 506 of the base 110. The slits 504 have a width that allows the edges 506 of the rim 108 of another device 100 to be positioned within the slits 504. The slits 504 allow multiple devices 100 to be stacked one atop another and interlocked. This allows for easy storage and prevents the stacks of devices 100 from falling over. The slits 504 interlock with the rim 108 and securely hold the devices 100 in a stacked arrangement for storage. Specifically, when the devices 100 are fully collapsed and nestled together, the slits 504 will interlock with the rigid rim edges 506, allowing users to stack multiple devices 100 on top of each other. To use a device 100, a user simply takes one of the collapsed devices 100 from the stack and expands it by pulling the device 100 open and then placing it in a desired position for planting a plant 106 within.

Further, the base 110 of the body component 102 comprises a plurality of aeration holes 508. The aeration holes 508 are through holes within the base 110 to allow water from the soil, not absorbed by the plant 106, to flow through. The plurality of aeration holes 508 traverses through the base 110 and are distributed across the base 110. The plurality of aeration holes 508 keeps the soil within the base component 102 healthy, allowing water and air to pass through, as needed.

In one embodiment, the body component 102 can be positioned on a reservoir tray 510. The reservoir tray 510 functions as a reservoir and is used to collect water until the water is absorbed by the plant 106 and/or flower inside the body component 102. Typically, the reservoir tray 510 is not secured to the base 110 but allows the body component 102 to merely rest on the reservoir tray 510. Thus, the reservoir tray 510 can be easily removed, when not needed.

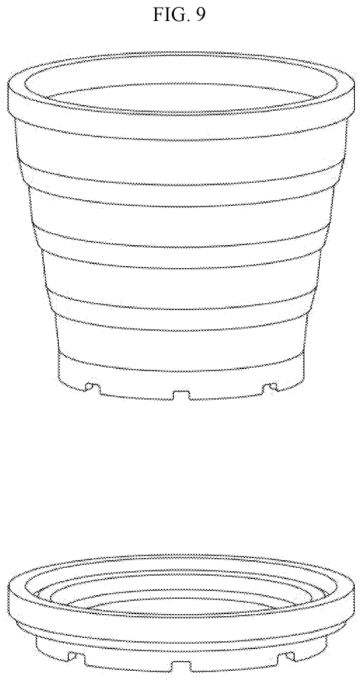

FIG. 6 illustrates a flowchart of the method of stacking planting pots with ease. The method includes the steps of at 600, providing a collapsible plant pot device comprising a body component with collapsible sections. The method also comprises at 602, extending the body component to hold a plant. Further, the method comprises at 604, collapsing the body component down for storage. The method also comprises at 606, stacking one collapsed body component onto another collapsed body component. Finally, the method comprises at 608, interlocking the collapsed body components together via the slits on the bottom of each body component.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “collapsible plant pot device”, “plant pot device”, “collapsible device”, and “device” are interchangeable and refer to the collapsible plant pot device 100 of the present invention.

Notwithstanding the foregoing, the collapsible plant pot device 100 of the present invention can be of any suitable size and configuration as is known in the art without affecting the overall concept of the invention, provided that it accomplishes the above-stated objectives. One of ordinary skill in the art will appreciate that the collapsible plant pot device 100 as shown in FIGS. 1-6 is for illustrative purposes only, and that many other sizes and shapes of the collapsible plant pot device 100 are well within the scope of the present disclosure. Although the dimensions of the collapsible plant pot device 100 are important design parameters for user convenience, the collapsible plant pot device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A collapsible plant pot device that provides a user with a collapsible pot for a potted plant, the collapsible plant pot device comprising:
a body component;
wherein the body component comprises a series of annular pleats; and
further wherein the series of annular pleats allow the body component to be extended or retracted, as needed for storage or based on size of a plant or flower to be potted within.

2. The collapsible plant pot device of claim 1, wherein the body component is a pot-shaped structure used to contain soil and plant or flower substances.

3. The collapsible plant pot device of claim 2, wherein the body component is available in multiple sizes, allowing users to pot varying sizes of plants or flowers.

4. The collapsible plant pot device of claim 3, wherein the body component comprises a rim, a base, and a series of annular pleats that form a sidewall of the body component.

5. The collapsible plant pot device of claim 4, wherein the rim is protective edge of the body component and the base is structural foundation of the body component, such that the rim and the base are rigid and act to maintain the collapsible plant pot device in an extended position.

6. The collapsible plant pot device of claim 5, wherein the series of annular pleats are a set of foldable sections of the body component, which enables collapsibility of the collapsible plant pot device.

7. The collapsible plant pot device of claim 6, wherein the series of annular pleats comprise a beginning pleat, at least one intermediate pleat, and an ending pleat.

8. The collapsible plant pot device of claim 7, wherein the beginning pleat is smallest, lowest pleat of the body component when in an upright position, each of the at least one intermediate pleats proceed the beginning pleat and is gradually larger than a preceding pleat along the body component when in an upright position, and the ending pleat is largest and highest pleat of the body component when in an upright position.

9. The collapsible plant pot device of claim 8, wherein each of the series of annular pleats comprises a first edge and a second edge, wherein the second edge is larger than the first edge for each of the series of annular pleats.

10. The collapsible plant pot device of claim 9, wherein the rim of the body component comprises a recessed ring around its inside perimeter to allow for stacking of multiple collapsible plant pot devices on top of each other.

11. The collapsible plant pot device of claim 10, wherein the base of the body component comprises at least one pair of slits positioned on opposing sides of the base.

12. The collapsible plant pot device of claim 11, wherein the at least one pair of slits are rectangular openings in edges of the base, that allow edges of the rim of another collapsible plant pot device to be positioned within the at least one pair of slits, to allow multiple collapsible plant pot devices to be stacked one atop another and interlocked.

13. The collapsible plant pot device of claim 12, wherein the base of the body component comprises a plurality of aeration holes in the base.

14. A collapsible plant pot device that provides a user with a collapsible pot for a potted plant, the collapsible plant pot device comprising:
a body component comprises a rim, a base, and a series of annular pleats that form a sidewall of the body component; and
wherein the series of annular pleats allow the body component to be extended or retracted, as needed for storage or based on size of a plant or flower to be potted within;
wherein the series of annular pleats comprise a beginning pleat, at least one intermediate pleat, and an ending pleat to allow for foldability;
wherein the beginning pleat is smallest, lowest pleat of the body component when in an upright position, each of the at least one intermediate pleats proceed the beginning pleat and is gradually larger than a preceding pleat along the body component when in an upright position, and the ending pleat is largest and highest pleat of the body component when in an upright position;
wherein the rim of the body component comprises a recessed ring around its inside perimeter to allow for stacking of multiple collapsible plant pot devices on top of each other;
wherein the base of the body component comprises at least one pair of slits positioned on opposing sides of the base to allow edges of the rim of another collapsible plant pot device to be positioned within the at least one pair of slits, to allow multiple collapsible plant pot devices to be stacked one atop another and interlocked;
wherein the base of the body component comprises a plurality of aeration holes in the base;
wherein the body component is arranged into an operative configuration by holding down the base and extending the body component by pulling the rim away from the base; and
further wherein the body component is arranged into a collapsed configuration by pushing the rim down towards the base.

15. The collapsible plant pot device of claim 14, wherein the body component is available in a variety of colors and designs.

16. The collapsible plant pot device of claim 14, wherein the body component is manufactured from silicone, plastic, or recycled, biodegradable materials, or a combination of such materials.

17. The collapsible plant pot device of claim 14 further comprising a plurality of indicia.

18. The collapsible plant pot device of claim 14, wherein the body component can be positioned on a reservoir tray for collecting residual water from the body component.

19. The collapsible plant pot device of claim 14, wherein the rim is protective edge of the body component and the base is structural foundation of the body component, such that the rim and the base are rigid and act to maintain the collapsible plant pot device in an extended position.

20. A method of stacking planting pots with ease, the method comprising the following steps:
providing a collapsible plant pot device comprising a body component with collapsible sections;
extending the body component to hold a plant;
collapsing the body component down for storage;
stacking one collapsed body component onto another collapsed body component; and interlocking the collapsed body components together via the slits on the bottom of each body component.
